(19) United States
(12) Patent Application Publication
(10) Pub. No.: US 2022/0305705 A1
(43) Pub. Date: Sep. 29, 2022

(54) INJECTION MOLDING DIE

(71) Applicant: HONDA MOTOR CO., LTD., Tokyo (JP)

(72) Inventors: Masahiro YASUDA, Tokyo (JP); Daisuke TOKUNOU, Tokyo (JP); Kenya HASEGAWA, Tokyo (JP)

(21) Appl. No.: 17/678,009

(22) Filed: Feb. 23, 2022

(30) Foreign Application Priority Data
Mar. 26, 2021 (CN) 202110323489.6

(51) Int. Cl. B29C 45/00; B29C 45/26; B29C 45/73

(52) U.S. Cl. CPC B29C 45/0025; B29C 45/2602; B29C 45/73; B29C 2045/1784

(57) ABSTRACT

Provided is an injection molding die capable of adjusting a size of a support member, preventing bending of a mold, and preventing occurrence of burrs without removing the mold and making the support member again. The present invention provides an injection molding die including a fixed mold and a movable mold that face each other, the fixed mold and the movable mold being clamped to form a cavity for molding a molded product, the injection molding die further including at least one support member that is provided to abut on a surface opposite to a surface on which the cavity is formed in either or both of the fixed mold and the movable mold, the at least one support member being a stretchable support member in a direction of the cavity.

This application is based on and claims the benefit of priority from Chinese Patent Application No. CN2021103234E9.6, filed on 26 Mar. 2021, the content of which is incorporated herein by reference.

### BACKGROUND OF THE INVENTION

### Field of the Invention

The present invention relates to an injection molding die.

### Related Art

FIG. 4 is a schematic diagram showing a situation where injection molding is performed using an injection molding apparatus according to the related art. The injection molding apparatus includes an injection molding die 10 including a fixed mold 14 and a movable mold 24. In injection molding, a molten resin is filled in a cavity, which is formed by mold clamping of the fixed mold 14 and the movable mold 24 facing each other, at a high pressure, thereby forming a molded product 40. In the injection molding apparatus shown in FIG. 4, the fixed mold 14 and the movable mold 24 are mounted on the injection molding apparatus by mounting plates 12 and 22, respectively, so as to be disposed to face each other. A support member 16 is provided between the fixed mold 14 and the mounting plate 12, and a support member 26 is provided between the movable mold 24 and the mounting plate 22. The injection molding die 10 includes an ejector pin 25 provided to take out the molded product 40.

During injection molding, when the movable mold 24 or the fixed mold 14 is bent due to an insufficient support force of the support member 26 or the support member 16 and a clearance is formed in a parting line 34 which is a split surface between both of the molds, a resin leaks and burrs occur on the molded product. FIG. 4 schematically shows a state in which only the movable mold 24 is bent and burrs occur on the parting line 34 for easy description.

As a technique for preventing burrs, a method is disclosed in Japanese Unexamined Patent Application, Publication No. 2006-181736 in which a shim is provided between a mounting plate and a mold of an injection molding machine to support the mold, thereby reducing bending of the mold during injection molding. The “shim” used in the method corresponds to the “support members” in the example shown in FIG. 4. According to the method, the molded product is actually molded by the manufactured molds, and thus a thickness of the shim is adjusted by replacement with a shim having a different thickness with reference to burrs that actually occur, but the thickness of the shim is repeatedly adjusted until conditions are found in which burrs do not occur.

Japanese Patent No. 5720460 discloses a technique in which a support member capable of being elastically deformed is provided on an opposite side of a cavity surface in a mold to prevent burrs. The support member includes a plurality of support columns that are distributed. Such a technique is configured to adjust a cross-sectional area of each of the support columns such that a molding pressure is uniformly generated on a contact surface between a fixed mold and a movable mold.
Patent Document 1: Japanese Unexamined Patent Application, Publication No. 2006-181736
Patent Document 2: Japanese Patent No. 5720460

### SUMMARY OF THE INVENTION

However, in order to replace the shim having a different thickness as in Japanese Unexamined Patent Application, Publication No. 2006-181736, it is necessary to remove and adjust the mold each time replacement, which requires labor and time. Adjusting the cross-sectional area of each of the support columns as in Japanese Patent No. 5720460 is to make the support member again, and it is necessary to make the support member again many times by trial and error until the molding pressure is uniformly generated on the contact surface between the fixed mold and the movable mold.

The present invention is to provide an injection molding die capable of adjusting the size of the support member, preventing the bending of the mold, and preventing occurrence of burrs without removing the mold and making the support member again.

(1) The present invention provides an injection molding die including a fixed mold and a movable mold that are disposed facing each other, the fixed mold and the movable mold being mold clamped to form a cavity for molding a molded product, the injection molding die further including at least one support member that is provided to abut on a surface opposite to a surface on which the cavity is formed in either or both of the fixed mold and the movable mold, and the at least one support member being a stretchable support member in a direction of the cavity.

(2) In the injection molding die according to (1), the stretchable support member may be provided in plurality, and each of the plurality of stretchable support members may be configured to be stretchable independently.

(3) In the injection molding die according to (1) or (2), the injection molding die may further include: a heater provided on the stretchable support member; and an adjuster that adjusts a temperature of the heater, wherein the stretchable support member may be thermally expanded and stretched by heating of the heater.

(4) In the injection molding die according to (3), the stretchable support member may be made of metal.

(5) The present invention provides an injection molding method of injecting a molten resin into a cavity formed by mold clamping a fixed mold and a movable mold disposed facing each other to mold a molded product, the method including: predicting whether a burr will occur in the molded product; and adjusting a length of a stretchable support member, when the burr is predicted to occur in the prediction step, by stretching the stretchable support member, in a direction of the cavity, the stretchable support member being provided to abut on a surface opposite to a surface on which the cavity is formed in either or both of the fixed mold and the movable mold.

(6) In the injection molding method according to (5), the prediction step may include predicting a position where the burr will occur, and the adjusting step may include stretching the stretchable support member corresponding to a position where the burr will occur, among the stretchable support members provided in plurality, and adjusting the length of the stretchable support member.

(7) In the injection molding method according to (5) or (6), the adjustment step may include adjusting a temperature of a heater provided on the stretchable support member to thermally expand the stretchable support member and adjusting the length of the stretchable support member.

According to the present invention, it is possible to adjust the size of the support member, prevent the bending of the mold, and prevent the occurrence of burrs without removing the mold and making the support member again.

### BRIEF DESCRIPTION OF THE DRAWINGS

FIG. 1 is a schematic diagram of an injection molding apparatus including an injection molding die according to a first embodiment of the present invention;

FIG. 2 is a schematic diagram showing a state where injection molding is performed using the injection molding apparatus shown in FIG. 1;

FIG. 3 is a schematic diagram of an injection molding apparatus including an injection molding die according to a second embodiment of the present invention; and

FIG. 4 is a schematic diagram showing a situation where injection molding is performed using an injection molding apparatus according to the related art.

### DETAILED DESCRIPTION OF THE INVENTION

Embodiments of the present invention will be described in detail below with reference to the drawings.

### First Embodiment

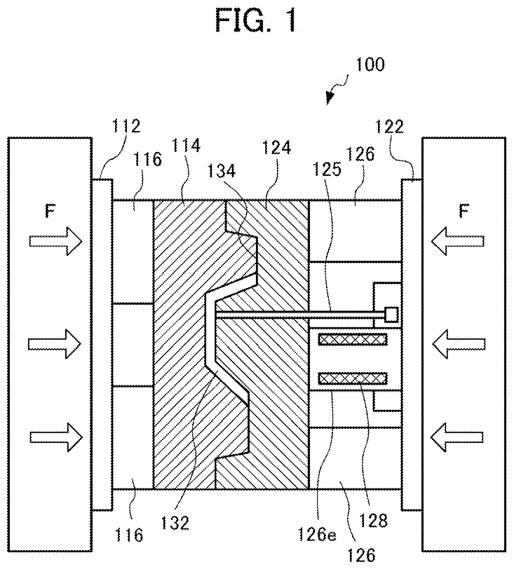

FIG. 1 is a schematic diagram of an injection molding apparatus including an injection molding die according to a first embodiment of the present invention. An injection molding die 100 in the injection molding apparatus shown in FIG. 1 includes a fixed mold 114, a movable mold 124, a support member 116, a support member 126, and an ejector pin 125.

The fixed mold 114 and the movable mold 124 are disposed so as to face each other, and are mounted on mold clampers of the injection molding apparatus by mounting plates 112 and 122, respectively. The support member 116 is provided between the fixed mold 114 and the mounting plate 112, and the support member 126 is provided between the movable mold 124 and the mounting plate 122.

FIG. 1 shows a state in which mold clamping of the injection molding die is completed. In this case, as indicated by white arrows shown in the drawing, a mold clamping force F is applied to the fixed mold 114 and the movable mold 124 from both sides by the mold clamper. By the mold clamping, a cavity 132 is formed between the fixed mold 114 and the movable mold 124 to mold a molded product. As shown in FIG. 1, the support member 116 abuts on a surface opposite to a surface of the fixed mold 114 on which the cavity 132 is formed, and supports the fixed mold 114. On the other hand, the support member 126 abuts on a surface opposite to a surface of the movable mold 124 on which the cavity 132 is formed, and supports the movable mold 124.

FIG. 1 shows three support members 126 that support the movable mold 124, but the support member, which is located closer to a center as one of the three support members, is a stretchable support member that can be stretched in a direction of the cavity 132 (a direction directed to a left in FIG. 1) and is indicated by reference numeral “126e” in the drawing. The stretchable support member 126e is made of metal. For example, the stretchable support member 126e may be made of a steel material such as SS400 or S50C.

The stretchable support member 126e is provided with a heater 128, and a temperature of the heater 128 can be adjusted by an adjuster (not shown). The stretchable support member 126e can be thermally expanded and stretched by heating of the heater 128. An example of the heater 128 may include a band heater or a cartridge heater.

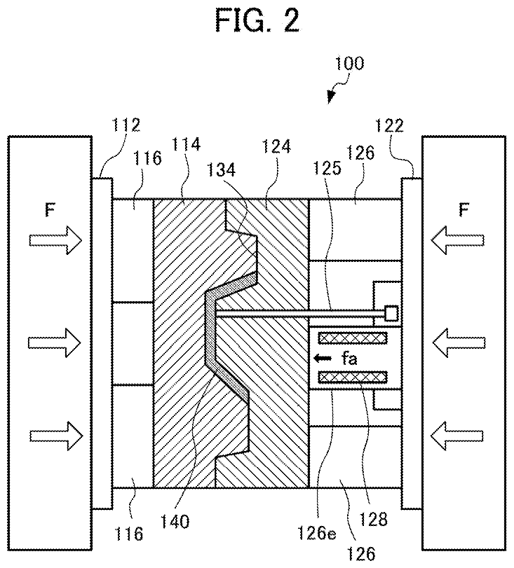

FIG. 2 is a schematic diagram showing a state where injection molding is performed using the injection molding apparatus according to the first embodiment shown in FIG. 1. In the state shown in FIG. 2, a resin is injected into the cavity 132, and thus a molded product 140 is formed. Thereafter, the mold is opened and the molded product 140 is taken out by the ejector pin 125.

In the present embodiment, when the heater 128 is heated, the stretchable support member 126e is thermally expanded and is about to be stretched in the direction of the cavity. However, the stretchable support member 126e cannot be freely stretched due to the obstruction of the movable mold 124 that abuts on the stretchable support member 126e. As a result, a force fa due to thermal expansion is generated in the stretchable support member 126e as indicated by a black arrow shown in FIG. 2, and is applied to the movable mold 124.

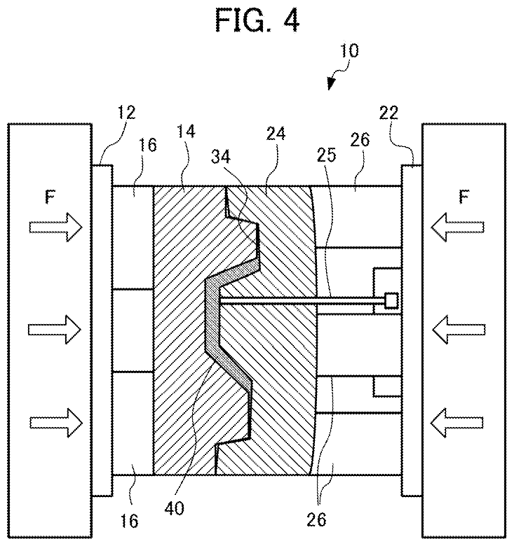

By adjusting (controlling) the temperature of the heater 128, the amount of thermal expansion of the stretchable support member 126e can be controlled, and the force fa applied to the movable mold 124 can be controlled. By appropriately applying the force fa to the movable mold 124, occurrence of bending such as that in the movable mold 24 shown in FIG. 4 can be prevented in the movable mold 124, whereby it is possible to prevent a formation of a clearance in a parting line 134 and occurrence of burrs.

According to the present embodiment, using the stretchable support member provided with the heater, the temperature of the heater can be adjusted to control the amount of thermal expansion of the stretchable support member, and the force fa applied to the movable mold can be controlled. Accordingly, it is not necessary to remove the mold whenever a support member or a shim having a different length (dimension in a mold clamping direction) is replaced. It is not necessary to remake a support member and adjust the size of the support member whenever the force fa applied from the support member is changed.

### Second Embodiment

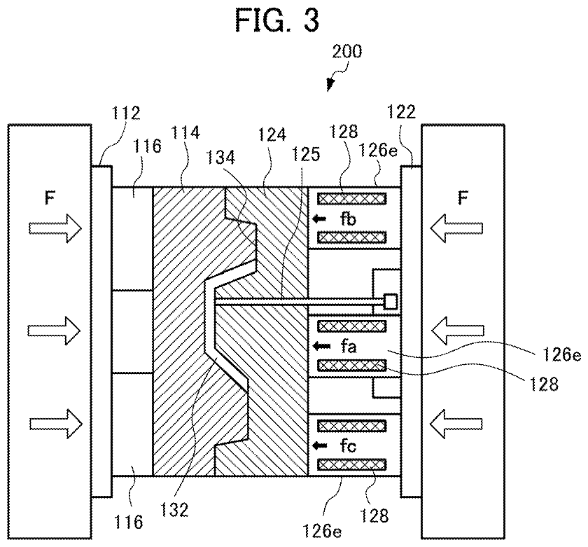

FIG. 3 is a schematic diagram of an injection molding apparatus including an injection molding die according to a second embodiment of the present invention. An injection molding die 200 according to the present embodiment is a modification of the injection molding die 100 according to the first embodiment. In the present embodiment, parts, members, portions, elements, and components having the same functions as those in the first embodiment are denoted by the same reference numerals as those in the first embodiment, and will not be described.

The injection molding die 200 is different from the injection molding die 100 according to the first embodiment in that, as shown in FIG. 3, all of three support members on the movable mold are stretchable support members 126e and can apply forces fa, fb, and fc to the movable mold 124, respectively. In other words, according to the second embodiment, a plurality of stretchable support members 126e are provided. Each of these stretchable support members 126e can be stretched independently. Specifically, a heater 128 provided on each of the stretchable support members 126e can individually adjust a temperature, and can individually control the amount of thermal expansion of the stretchable support member 126e. Accordingly, the forces fa, fb, and fc applied to the movable mold 124 from the three stretchable support members 126e can be controlled, respectively.

According to the present embodiment, since the plurality of stretchable support members 126e are provided, it is possible to finely adjust distribution of the forces applied to the movable mold 124. For example, in the adjustment step, it is possible to stretch the stretchable support member 126e corresponding to a position where burrs occur, among the plurality of stretchable support members 126e, and to adjust the length thereof. As a specific example, the temperature of the stretchable support member 126e provided closer to a position where burrs are likely to occur is adjusted to be high, thereby increasing the amount of thermal expansion and strengthening the force applied to the movable mold 124. The temperature of the stretchable support member 126e provided closer to a position where burrs are unlikely to occur is adjusted to be low, thereby reducing the amount of thermal expansion and weakening the force applied to the movable mold 124. Alternatively, it is not necessary to adjust the temperature of the stretchable support member 126e provided closer to a position where burrs are unlikely to occur. According to the present embodiment, since the distribution of the forces applied to the movable mold 124 from the stretchable support members 126e can be finely adjusted, the effect of preventing burrs can be further enhanced.

The above-described embodiment is an embodiment in which a part or all of the support member 126 on the movable mold 124 is changed to the stretchable support member 126e, but the present invention is not limited to such an embodiment. In the present invention, a part or all of the support member 116 on the fixed mold 114 may be changed to a stretchable support member. With such a configuration, since bending can be prevented from occurring in the fixed mold, burrs can be prevented from occurring in the molded product. In the present invention, a part or all of the support member 126 on the movable mold 124 and, a part or all of the support member 116 on the fixed mold 114 may be changed to a stretchable support member. With such a configuration, the effect of preventing burrs can be further enhanced.

### Third Embodiment

The present embodiment is an embodiment of an injection molding method according to the present invention. The injection molding method according to the present embodiment may use the injection molding die according to the present invention described above. For example, as shown in FIGS. 1 and 2, a molten resin is injected into the cavity 132 formed by mold clamping of the fixed mold 114 and the movable mold 124 that face each other, thereby molding the molded product 140. The injection molding method according to the present embodiment includes a prediction step and an adjustment step.

In the prediction step, it is predicted whether burrs will occur in the molded product. For example, when injection molding is performed using the injection molding die according to the present invention described above, whether burrs will occur in the molded product 140 is predicted by computer simulation, experiment, or a combination of the computer simulation and the experiment.

In the adjustment step, when it is predicted in the prediction step that the burrs occur, the stretchable support member provided to abut on the surface opposite to the surface on which the cavity is formed in either or both of the fixed mold and the movable mold is stretched in the direction of the cavity to adjust the length thereof. When the stretchable support member is stretched in the direction of the cavity, a force is applied to the movable mold or the fixed mold on which the stretchable support member abuts. In the present embodiment, for example, when the injection molding die 100 shown in FIGS. 1 and 2 is used, the temperature of the heater 128 provided on the stretchable support member 126e as shown in FIG. 2 can be adjusted, whereby the stretchable support member 126e is thermally expanded to adjust the length thereof, and the force fa is applied to the movable mold 124.

By adjusting (controlling) the temperature of the heater 128, the amount of thermal expansion of the stretchable support member 126e can be controlled, and the force fa applied to the movable mold 124 can be controlled. By appropriately applying the force fa to the movable mold 124, occurrence of bending such as that in the movable mold 24 shown in FIG. 4 can be prevented in the movable mold 124, whereby it is possible to prevent occurrence of burrs in the molded product 140 that is molded by the injection molding.

In the prediction step, it is preferable to further predict the position where burrs occur. When the occurrence position of burrs is predicted in the prediction step, in the adjustment step, the stretchable support member provided closer to a position where burrs occur, among the plurality of stretchable support members may be stretched to adjust the length thereof.

In the present embodiment, for example, when the injection molding die 200 shown in FIG. 3 is used, the temperature of the stretchable support member 126e provided closer to the position where the burrs occur can be adjusted, whereby the stretchable support member 126e is thermally expanded to adjust the length thereof, and a force is applied to the movable mold 124. In this case, the temperature adjustment may not be performed or may be performed small on the stretchable support member 126e provided closer to the position where burrs do not occur or the position where burrs are unlikely to occur. In this way, since the distribution of the forces applied to the movable mold 124 from the stretchable support members 126e can be finely adjusted by the prediction of the position where the burrs occur, the effect of preventing burrs can be further enhanced.

Further, the mold may change with time due to wear and the like, and burrs may occur due to the change with time. The prediction step of the present embodiment also includes finding the occurrence of burrs due to the change with time by confirming the product being produced. When the occurrence of burrs due to the change with time is found, the stretchable support member is stretched in the adjustment step, and thus the force is applied to the movable mold or the fixed mold on which the stretchable support member abuts, as described above. Particularly, the stretchable support member corresponding to the position where the burrs occur may be stretched to adjust the length thereof. Accordingly, it is possible to prevent the occurrence of burrs due to the change with time that occur during cycle production.

Although the invention has been described above using the embodiments, the technical scope of the present invention is not limited to the scope described in the embodiments described above. It will be apparent to those skilled in the art that various changes or improvements can be made to the above-described embodiments. It is also apparent from the scope of the claims that the embodiments added with such changes or improvements can be included in the technical scope of the invention. For example, the above-described embodiments have been described in detail in order to explain the present invention in an easy-to-understand manner, but the present invention is not necessarily limited to all the configurations described above. A part of the configuration of each embodiment can be replaced with another configuration, and can also be deleted.

For example, the support member is stretched by the thermal expansion using the heater to generate the force to be applied in the above-described embodiments, but the present invention is not limited thereto. The support member may be stretchable by a slider mechanism or the like, and the support member may be stretched using an actuator.

### EXPLANATION OF REFERENCE NUMERALS

10, 100, 200 injection molding die
12, 112 mounting plate
14, 114 fixed mold
16, 116 support member
22, 122 mounting plate
24, 124 movable mold
25, 125 ejector pin
26, 126 support member
34, 134 parting line
40, 140 molded product
126e stretchable support member
128 heater
132 cavity

What is claimed is:

1. An injection molding die comprising a fixed mold and a movable mold that face each other, the fixed mold and the movable mold being mold clamped to form a cavity for molding a molded product,
the injection molding die further including at least one support member that is provided to abut on a surface opposite to a surface on which the cavity is formed in either or both of the fixed mold and the movable mold, and
the at least one support member being a stretchable support member in a direction of the cavity.

2. The injection molding die according to claim 1, wherein the stretchable support member is provided in plurality, and each of the plurality of stretchable support members is configured to be stretchable independently.

3. The injection molding die according to claim 1, further comprising: a heater provided on the stretchable support member; and
an adjuster that adjusts a temperature of the heater, wherein
the stretchable support member is thermally expanded and stretched by heating of the heater.

4. The injection molding die according to claim 3, wherein the stretchable support member is made of metal.

5. An injection molding method of injecting a molten resin into a cavity formed by mold clamping a fixed mold and a movable mold disposed facing each other to mold a molded product, the method comprising:
predicting whether a burr will occur in the molded product; and
adjusting a length of a stretchable support member, by stretching the stretchable support member, in a direction of the cavity, when the burr is predicted to occur in the prediction step, the stretchable support member being provided to abut on a surface opposite to a surface on which the cavity is formed in either or both of the fixed mold and the movable mold.

6. The injection molding method according to claim 5, wherein the prediction step comprises predicting a position where the burr will occur, and
the adjusting step comprises stretching the stretchable support member corresponding to a position where the burr will occur, among the stretchable support members provided in plurality, and adjusting the length of the stretchable support member.

7. The injection molding method according to claim 5, wherein the adjusting step comprises adjusting a temperature of a heater provided on the stretchable support member to thermally expand the stretchable support member and adjusting the length of the stretchable support member.
